(19) United States
(12) Patent Application Publication
(10) Pub. No.: US 2012/0221317 A1
(43) Pub. Date: Aug. 30, 2012

(54) OPERATING SYSTEM AND METHOD BASED ON SENSOR DATA

(75) Inventor: Min Kyung HWANG, Seoul (KR)

(73) Assignee: SAMSUNG ELECTRONICS CO. LTD., Suwon-si (KR)

(21) Appl. No.: 13/403,258

(22) Filed: Feb. 23, 2012

(30) Foreign Application Priority Data
Feb. 24, 2011 (KR) 10-2011-0016312

(51) Int. Cl. G06F 9/455

(52) U.S. Cl. 703/23

(57) ABSTRACT

A system for operating sensor data is provided. The system includes a portable terminal that includes at least one sensor, for activating a sensor according to a request signal transmitted from an upper terminal, for collecting sensor data of the sensor, and for transmitting the collected data to the upper terminal, and an upper terminal for controlling to transmit a request signal that requests sensor data collection to the portable terminal, and for applying the received sensor data to a virtual mobile application program to be installed in the portable terminal.

### PRIORITY

This application claims the benefit under 35 U.S.C. §119(a) of a Korean patent application filed on Feb. 24, 2011 in the Korean Intellectual Property Office and assigned Serial No. 10-2011-0016312, the entire disclosure of which is hereby incorporated by reference.

### BACKGROUND OF THE INVENTION

1. Field of the Invention

The present invention relates to a portable terminal. More particularly, the present invention relates to a method and system for operating sensor data, which collects sensor data of the portable terminal and to operate a virtual mobile simulator through the collected sensor data.

2. Description of the Related Art

Recently, a mobile communication terminal is widely used based on its portability. In particular, a mobile communication terminal may have other various functions as well as the main function of transmitting and receiving call information between speakers. For example, a portable terminal according to the prior art may have an MP3 function corresponding to a file replay function, or have an image collecting function corresponding to a digital camera which can collect images. Further, the portable terminal according to the prior art supports a function that can perform a mobile game or an arcade game, etc. In order to support the above-described various functions, the display area of the portable terminal is gradually increasing and the portable terminal includes high-performance hardware for supporting the various functions.

With the increased popularity of the portable terminal, various applications, for the portable terminal are being developed. However, the applications to be operated in the existing portable terminal are being developed through an upper terminal, which is connected with a keyboard and a mouse, etc., and includes high-performance hardware compared with the portable terminal, for example, a general-purpose computer terminal As such, developers of the various applications develop a virtual mobile application program to be applied to the portable terminal under a general-purpose computer terminal environment, and then install and operate the developed virtual mobile application program in the portable terminal.

However, as mentioned above, because the portable terminal and the general-purpose computer terminal have different specifications, and even though a virtual mobile application program is developed based on the virtual mobile simulator, it is difficult for the program to be optimized in the portable terminal As such, the virtual mobile application program, which is developed in the general-purpose computer terminal, has a problem that bugs and errors are generated in the process of applying the application program in the portable terminal In particular, various input signals generated in the existing portable terminal are substituted by signals arbitrarily generated in the general-purpose computer and the substituted signals are applied to the virtual mobile application program, which has resulted in a state which is different from the state operated in the actual portable terminal.

Therefore, a need exists for a system and method for operating sensor data that collects sensor data of the portable terminal and that operates the virtual mobile simulator based on the collected sensor data, without the above-described inconveniences caused when an application program is applied from a general purpose computer terminal to the portable terminal.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a system and method for operating sensor data, which may develop a virtual mobile application program according to an optimized portable terminal state even though a portable terminal environment is virtually provided by transmitting various sensor signals generated in a portable terminal to a upper terminal and applying the transmitted sensor signals to a virtual mobile application program.

In accordance with an aspect of the present invention, a system for operating sensor data is provided. The system includes a portable terminal that includes at least one sensor, for activating a sensor from at least one sensor according to a request signal transmitted from an upper terminal, for collecting sensor data of the sensor, and for transmitting the collected data to the upper terminal, and the upper terminal for controlling to transmit a request signal that requests sensor data collection to the portable terminal, and for applying the received sensor data to a virtual mobile application program to be installed in the portable terminal.

In accordance with another aspect of the present invention, a method for operating sensor data is provided. The method includes connecting a portable terminal including at least one sensor with an upper terminal, transmitting to the portable terminal a request signal that requests collection of sensor data of a sensor from the at least one sensor by the upper terminal, activating the sensor and collecting sensor data of the activated sensor by the portable terminal, transmitting the collected sensor data to the upper terminal, and applying the received sensor data to a virtual mobile application program to be installed in the portable terminal by the upper terminal.

According to a system and method for operating sensor data according to an exemplary embodiment of the present invention, the present invention may collect sensor data according to the actual operation state of a portable terminal, and check the application state of a virtual mobile application program operated in the upper terminal based on the collected sensor data.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic illustration of a configuration of a system for operating sensor data according to an exemplary embodiment of the present invention;

FIG. 2 is an illustration of a configuration of a portable terminal according to an exemplary embodiment of the present invention;

FIG. 3 is an illustration of a configuration of a controller according to an exemplary embodiment of the present invention;

FIG. 4 is a block diagram illustrating a configuration of an upper controller according to an exemplary embodiment of the present invention; and

FIG. 5 is a schematic illustration of a signal flow between system configurations for explaining a method of operating sensor data of the present invention according to an exemplary embodiment of the present invention

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

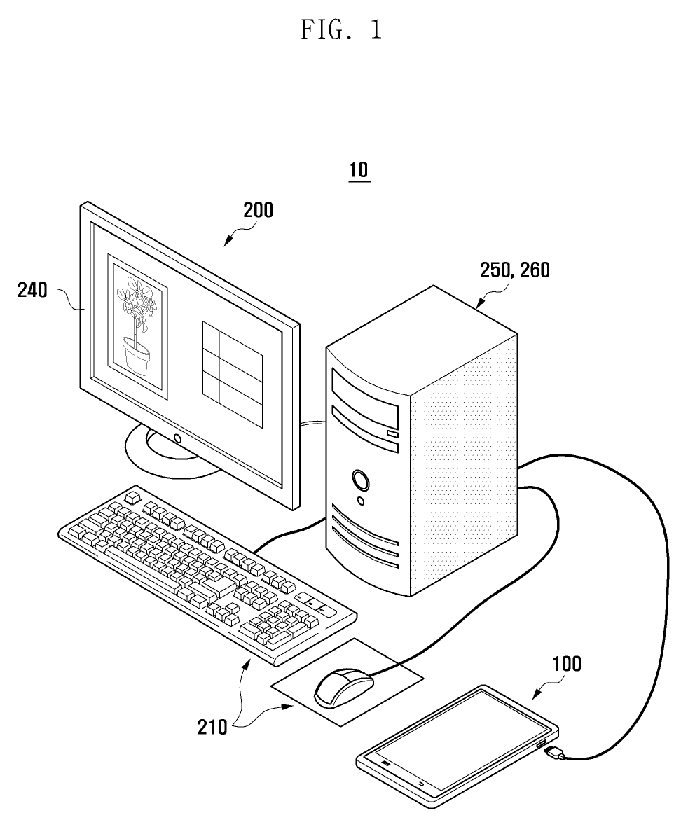

FIG. 1 is a schematic illustration of a configuration of a system for operating sensor data according to an exemplary embodiment of the present invention.

Referring to FIG. 1, a system 10 for operating sensor data may include a portable terminal 100 and an upper terminal 200.

The system 10 for operating sensor data having such a configuration according to the exemplary embodiment of the present invention collects sensor signals using a sensor unit including a plurality of sensors located in the portable terminal 100 according to the control of the upper terminal 200, and transmit the collected sensor signals to the upper terminal 200. Then, the upper terminal 200 performs various tests of a virtual mobile application program in an environment provided by the portable terminal 100 by operating the virtual mobile application program using the received sensor signals.

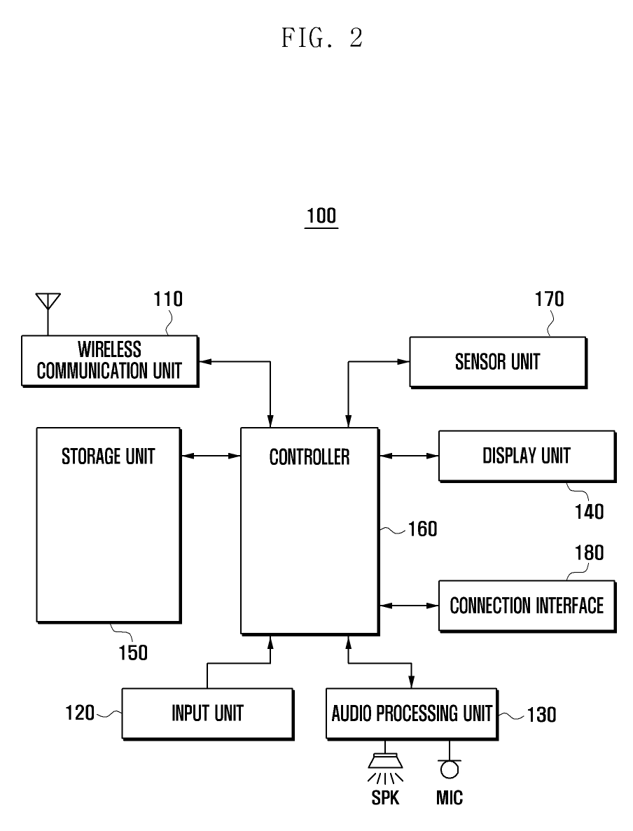

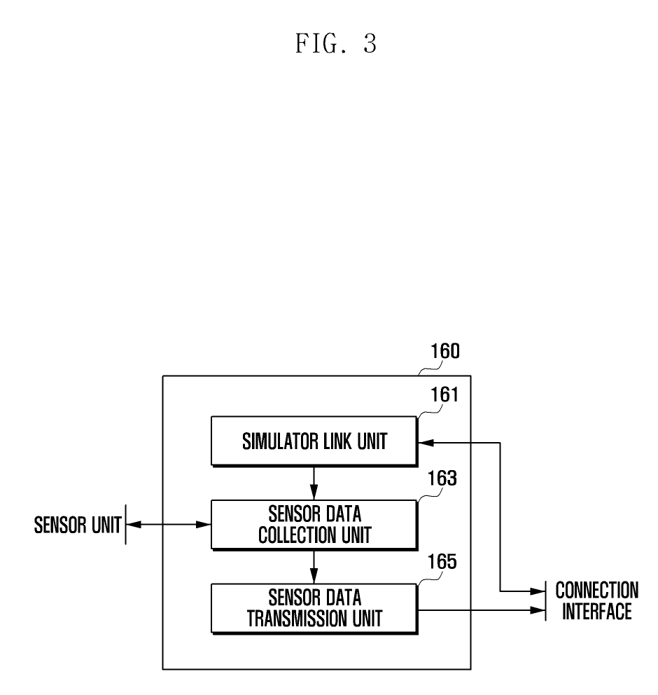

In particular, the portable terminal 100 may activate a sensor designated by the upper terminal 200 from the sensor unit including various sensors, and collect sensor signals according to the operation state change of the portable terminal 100. Further, the portable terminal 100 may transmit the sensor signals of the corresponding sensor to the upper terminal 200 at time points requested by the upper terminal 200, for example, at regular intervals or whenever requested by the upper terminal 200. In order to transmit the sensor signals, the portable terminal 100 may form a communication channel with the upper terminal 200. An exemplary configuration of the portable terminal 100 will be explained in more detail with reference to FIGS. 2 and 3.

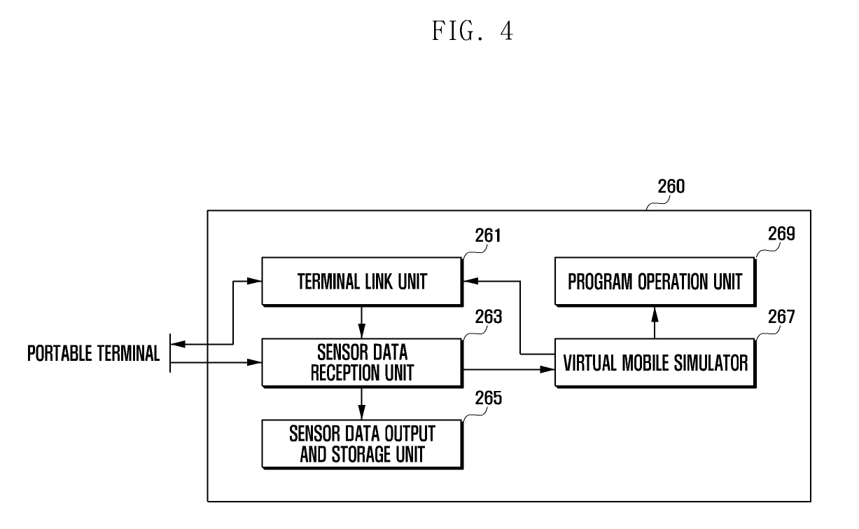

Further, the upper terminal 200 may activate a virtual mobile simulator which may virtually provide a portable terminal environment for forming a communication channel with the portable terminal 100 and for developing or testing a virtual mobile application program. The virtual mobile simulator may transmit corresponding signals to the portable terminal 100 according to user's control in order to use sensor signals of the actual portable terminal 100, which are requested in the process of developing or testing a virtual mobile application program. Further, if sensor signals corresponding to the signals are collected, the upper terminal 200 may provide the collected sensor signals to the virtual mobile simulator, and determine which operation the virtual mobile application program performs by ultimately applying the corresponding sensor signals to the virtual mobile application program. The upper terminal 200 may be a terminal where a virtual mobile simulator has been installed, which develops a virtual mobile application program to be operated in the portable terminal 100 by mounting a relatively high-performance hardware compared with the portable terminal 100. Such an upper terminal 200 may include an upper terminal input unit 210 like a mouse or a keyboard, an upper terminal display unit 240 which outputs a screen according to activation of a virtual mobile simulator and a virtual mobile application program, an upper terminal storage unit 250 which stores the virtual mobile simulator and the virtual mobile application program and an upper terminal controller 260 which controls the signal flow between the above-explained components to support the development or test of a virtual mobile application program. The upper terminal 200 will be explained later in more detail with reference to FIG. 4.

As explained above, the system 10 for operating sensor data according to an exemplary embodiment of the present invention collects actual sensor signals using a sensor unit located in the portable terminal 100 and then applies and operates the collected sensor signals in the virtual mobile application program when developing or testing a virtual mobile application program to be operated in the portable terminal 100. As such, the system 10 for operating sensor data may minimize errors or bugs that may be generated at the time point operated in the portable terminal 100 by allowing operation based on the data operated in the actual portable terminal 100 even though a virtual mobile application program is developed and tested in the upper terminal 200.

FIG. 2 is an illustration of a configuration of a portable terminal 100 according to an exemplary embodiment of the present invention.

Referring to FIG. 2, the portable terminal 100 may include a wireless communication unit 110, an input unit 120, an audio processing unit 130, a display unit 140, a storage unit 150, a sensor unit 170 and a controller 160.

The portable terminal 100 may collect various sensor data related with the portable terminal 100 and transmit the collected sensor data to the upper terminal 200 using the sensor unit 170 in order to support sensor data operation. At this time, the portable terminal 100 may receive a request signal that requests collection of certain sensor data from the upper terminal 200, collect sensor data corresponding to the request signal, and transmit the collected sensor data to the upper terminal 200. At this time, the portable terminal 100 may allow a user to easily recognize the collection process of the requested sensor data by outputting a request signal transmitted by the upper terminal 200 and sensor data corresponding to the request signal, etc. Hereinafter, the role and function of each component of the portable terminal 100 for supporting operation of sensor data of the exemplary embodiment of the present invention will be explained in more detail.

The wireless communication unit 110 forms a communication channel for a voice call, a communication channel for a video call, and a communication channel for data transmission under the control of the controller 160. That is, the wireless communication unit 110 may form a voice call channel, a data transmission channel and a video call channel between mobile communication systems. To this end, the wireless communication unit 110 may include a wireless frequency transmission unit that up-converts and amplifies the frequency of a transmitted signal, and a wireless frequency reception unit that low-noise-amplifies and down-converts the received signal. In particular, the wireless communication unit 110 may transmit sensor data collected by the sensor unit 170 to the upper terminal 200. To this end, the upper terminal 200 may include a communication module that may communicate with the wireless communication unit 110. Further, the wireless communication unit 110 may be activated to detect an interference phenomenon with the sensor unit 170, and the sensor data may be collected in the sensor unit 170 in the state where the wireless communication unit 110 is activated. Further, in case the portable terminal 100 does not support a separate communication function, the wireless communication unit 110 may be omitted.

The input unit 120 includes a plurality of input keys and function keys for receiving the input of number or letter information and setting various functions. The function keys may include a direction key, a side key, a shortcut key, etc., which are set to perform a certain function. In particular, the input unit 120 may generate an input signal for activating the sensor unit 170 according to the control of the user. At this time, the input unit 120 may generate an input signal for activating only a certain sensor among a plurality of sensors included in the sensor unit 170 according to the control of user. In case the portable terminal 100 is provided as a full touch screen type, the input unit 120 may be formed only as a side key, etc., and a function for the input of numbers or letters may be formed as a key map, thereby to be outputted to the touch screen. The input unit 120 may transmit generated input signals to the controller 160.

The audio processing unit 130 includes a speaker (SPK) for outputting audio data transmitted and received during the call, audio data included in a message, and audio data stored in the storage unit 150, etc., and a microphone (MIC) for collecting the user's voice or other audio signals during a call. Such an audio processing unit 130 may output a guide message that informs of completion of connection with the upper terminal 200, a message that informs of reception of a certain command from the upper terminal 200, a guide message that informs of completion of transmission of sensor signals, and a message that informs of disconnection with the upper terminal 200, etc. Such a guide message is outputted according to the user's setting, and may be omitted according to the change of the setting.

The audio processing unit 130 may also be configured with a Coder and Decoder (CODEC). The CODEC may include a data CODEC for processing packet data and an audio CODEC for processing an audio signal such as voice. Hence, when a moving picture is taken, the audio processing unit 130 converts an analog audio signal received through the MIC to digital audio data through the audio CODEC and provides the digital audio data to the controller 160. When a moving picture is reproduced, the audio processing unit 130 converts digital audio data to an analog audio signal through the audio CODEC and outputs the analog audio signal as audible sound through the SPK.

The display unit 140 displays information inputted by the user or information provided to the user as well as various menus of the portable terminal 100. That is, the display unit 140 may provide various screens according to the use of the portable terminal 100, for example, a standby screen, a menu screen, a message writing screen, a calling screen, a game screen, and a music replay screen, etc. Such a display unit 140 may be formed as a Liquid Crystal Display (LCD) or an Organic Light Emitted Diode (OLED), and in case the LCD or OLED is formed as a touch screen, the display unit 140 may be included in an input means. To this end, the display unit 140 may support a touch screen function by preparing a display panel and a touch sensor disposed on the display panel. In particular, the display unit 140 may provide various screens for supporting the operation mode of sensor data. For example, the display unit 140 may output a screen corresponding to the connection process with the upper terminal 200, a screen corresponding to the reception of a signal that requests sensor data received from the upper terminal 200, a screen corresponding to the operation that collects the sensor data and transmits the collected sensor data to the upper terminal 200, and a screen corresponding to the disconnection with the upper terminal 200, etc. according to each situation.

If the display unit 140 is provided as an LCD, the display unit 140 may include a controller for controlling the LCD, a video memory in which image data is stored and an LCD element. If the LCD is provided as a touch screen, the display unit 140 may perform a part or all of the functions of the input unit 120.

The storage unit 150 may store an application program that is necessary in operating a function, an application program for replaying various stored files, a key map or a menu map, etc., for operating a touch screen in case the portable terminal 100 adopts a touch screen. Here, the key map and menu map may be formed in various forms, respectively. That is, the key map may be a keyboard map, a 3*4 key map, a QWERTY key map, etc., and may be a control key map for controlling operation of a currently activated application program. Further, the menu map may be a menu map for the control of operation of a currently activated application program, and may be a menu map having various menus provided by the portable terminal 100 as items. Such a storage unit 150 may broadly include a program area and a data area.

The program area may store an operating system for booting the portable terminal 100 and operating each of the above explained components, and an application program for replaying various files, for example, a music replay application program for replaying sound sources, an image output application program for outputting pictures, etc., and a moving picture application program, etc. In particular, the program area may store a link program for linking with the upper terminal 200, and a sensor support application program for activation of the sensor unit 170.

The link program is loaded to the controller 160 when the upper terminal 200 is linked with the portable terminal 100, and controls transmission and reception of various signals that are necessary for linking with the upper terminal 200. Such a link program may allow the controller 160 to confirm a link interface between the upper terminal 200 and the portable terminal 100, and support transmission and reception of initial signals that are necessary for the link according to the interface. That is, the link program allows the controller 160 to transmit a confirmation signal for confirmation of the upper terminal 200 when connected to the upper terminal 200, and a communication channel that is necessary for communication through the confirmation process of the received response signal. At this time, in case a certain driver is necessary in linking with the upper terminal 200, the link program may search for the corresponding driver and install the driver.

The sensor support application program may be loaded to the controller 160 in the state where a communication channel is formed between the portable terminal 100 and the upper terminal 200 according to the link program, and allows the controller 160 to analyze a command received from the upper terminal 200, and to perform the function of the portable terminal 100 according to a command. In particular, in case a request signal, which requests a collection of certain sensor data from the upper terminal, is received, the sensor support application program may allow the controller 160 to control and activate a sensor corresponding to the request signal. Further, the sensor support application program collects sensor data corresponding to the state change of the portable terminal 100 based on the activated sensor. At this time, the sensor support application program may allow the controller 160 to control and check sensor data collection time information included in the request signal transmitted by the upper terminal 200, and collect and transmit sensor data according to the collection time information.

The data area is an area where data generated according to the use of the portable terminal 100 is generated, and may store various sets of content. Further, in case the display unit 140 is implemented as a touch screen, the data area may store user's input inputted through the touch screen. In particular, the data area may temporarily store a request signal transmitted from the upper terminal 200, and temporarily store sensor data collected from the sensor according to the request signal.

The sensor unit 170 may include a plurality of sensors for collecting sensor data to be transmitted to the upper terminal 200. That is, the sensor unit may include various sensors such as a speed and acceleration detection sensor, a position detection sensor, an altitude detection sensor, a direction detection sensor, and an image collection sensor, etc. For example, the sensor unit 170 may include a Global Positioning System (GPS) sensor for detecting a position, an acceleration sensor and gyro sensor for detecting a moving direction, an altitude sensor and geomagnetic sensor for detecting an altitude, etc. One or more of the plurality of sensors included in the sensor unit 170 may be activated independently or at the same time according to the transmitted request signal. For example, the acceleration sensor and the direction sensor of the sensor unit 170 may be activated at the same time according to the control of the controller 160, and the altitude sensor and the acceleration sensor may also be activated at the same time according to the control of the controller 160. The sensor data collection period of each sensor of the sensor unit 170 may be determined according to the request signal transmitted by the upper terminal 200. That is, the sensor data collection period may be determined according to certain time points or certain periods requested by the upper terminal 200 according to the request signal.

The connection interface 180 may be a physical device that forms a communication channel between the portable terminal 100 and the upper terminal 200. In case the portable terminal 100 and the upper terminal 200 are connected by a wired cable, such a connection interface 180 may be formed in the form of an interface that supports a wired serial communication, such as a Universal Serial Bus (USB) interface, and a Universal Asynchronous Receiver/Transmitter (UART) interface, etc. In case the connection interface 180 includes an interface that supports a serial communication, the sensor data operation system 10 may further include a cable in order to connect the portable terminal 100 with the upper terminal 200. Further, the connection interface 180 may be configured in various wireless communication interface forms such as a Bluetooth, Zigbee, and Ultra Assynchronous Wide Band (UWB), etc. In such a case, the sensor data operation system may not include a separate cable, and the portable terminal 100 and the upper terminal may include a near field communication module for forming a near field communication channel. The above described connection interface 180 supports transmission of a request signal from the upper terminal 200 to the portable terminal 100 and transmission of sensor data from the portable terminal 100 to the upper terminal 200.

The controller 160 performs the initialization process by controlling power supply to each component of the portable terminal 100, and controls a signal flow for supporting sensor data operation for each component when the initialization process is completed. To this end, the controller 160 may include a configuration as shown in FIG. 3.

FIG. 3 is an illustration of a configuration of a controller according to an exemplary embodiment of the present invention.

Referring to FIG. 3, the controller 160 may include a simulator link unit 161, a sensor data collection unit 163, and a sensor data transmission unit 165.

The simulator link unit 161 controls transmission and reception of signals that are necessary for linking with the upper terminal 200 if the upper terminal 200 is connected to the connection interface 180. The upper terminal 200 may substantially operate a virtual mobile simulator that supports a virtual mobile application program for operating sensor data. As such, the simulator link unit 161 may control transmission and reception of initial signals for linking the portable terminal 100 with a virtual mobile simulator 267 which is a program operated in the upper terminal 200 and described in more detail below with reference to FIG. 4.

If a communication channel is formed by completion of the initial link between the portable terminal 100 and the upper terminal 200 by the simulator link unit 161, the operator of the upper terminal 200 may transmit a request signal that requests sensor data to the portable terminal 100. Such a function support may be performed by the virtual mobile simulator operated in the upper terminal 200. That is, the virtual mobile simulator may generate various input signals related with the portable terminal 100 for the development and the test of a virtual mobile application program, and may output a screen interface in order for the generation of various input signals to be controlled by the operator. The operator may request generation of various input signals which are necessary for developing or testing the virtual mobile application program through the screen interface. In particular, the operator may request collection of sensor data related with a certain sensor of the portable terminal. The virtual mobile simulator may generate a request signal that requests collection of sensor data and transmit the generated request signal to the portable terminal 100. At this time, the virtual mobile simulator may receive information about the types of the sensor and sensor data collection time from user's input, generate a request signal including the received information, and transmit the generated request signal to the portable terminal 100.

In case the above-described request signal is received from the upper terminal 200, the sensor data collection unit 163 may activate at least one sensor by checking the request signal, and collect the sensor data of the activated sensor according to the collection time information included in the request signal. To this end, the sensor data collection unit 163 may control activation of the sensor support application program, and control the power supply and initialization process of a certain sensor of the sensor unit 170 according to the request signal. The sensor data collection unit 163 may transmit sensor data transmitted from the activated sensor to the sensor data transmission unit 165.

The sensor data transmission unit 165 transmits sensor data transmitted by the sensor data collection unit 163 to the upper terminal 200. Such a sensor data transmission unit 165 may transmit sensor data using a communication channel which is already formed between the upper terminals 200 through the connection interface 180. The sensor data transmission time point of such a sensor data transmission unit 165 may be adjusted according to the sensor data collection time of the sensor data collection unit 163.

Further, the sensor data transmission unit 165 may output sensor data collected by the sensor data collection unit 163 to the display unit 140. As such, the user may check which sensor data is collected according to the operation state of the portable terminal 100 and how the collected sensor data is changed. Such an output function of sensor data may be changed according to the user's setting, and in case the corresponding function is operated in the upper terminal 200, the function may be deactivated.

As explained above, the configuration of the portable terminal 100 for operating sensor data forms a communication channel with the upper terminal 200 through the connection interface 180, obtains sensor data of the selective sensors according to the form requested by the upper terminal 200 at requested time points, and transmits the obtained sensor data.

FIG. 4 is a block diagram illustrating a configuration of an upper terminal controller according to an exemplary embodiment of the present invention.

Referring to FIG. 4, the upper terminal controller 260 may include a terminal link unit 261, a sensor data reception unit 263, a sensor data output and storage unit 265, a virtual mobile simulator 267, and a program operation unit 269.

The upper terminal controller 260 having such a configuration may provide a virtual mobile terminal environment by activating a virtual mobile simulator 267 for developing or testing a virtual mobile application program. To this end, the operator may request activation of the virtual mobile simulator 267 through selection of a menu, etc. provided by the upper terminal 200.

The virtual mobile simulator 267 is activated according to the activation request of the operator, and may output the screen interface in the upper terminal display unit 240 for loading and controlling the virtual mobile application program. For example, the virtual mobile simulator 267 may provide various environments such as a calling environment of a portable terminal, a file replay environment in a portable terminal, a file search environment, a web connection environment, a broadcast receiving environment, a message writing environment, and an SNS service environment, etc. To this end, the screen interface may include items for selecting each of the above described environments. In particular, the screen interface may include a sensor unit operation item that may select the sensor unit operation environment of the exemplary embodiment of the present invention. The sensor unit operation item may receive sensor data provided by the portable terminal from various sensors, and may transmit the received sensor data to the program operation unit 269. Here, the virtual mobile simulator 267 may include a screen interface where information on the types of the sensors installed in the portable terminal 100 is collected by communicating with the connected portable terminal 100, and the sensor unit operation item is included according to the collected information. That is, the virtual mobile simulator 267 may request information on the types of sensors installed in the portable terminal 100 while performing the initial process for linking with the portable terminal 100, and if the information of the types of the sensors is received, the virtual mobile simulator 267 may configure a screen interface based on the received information. As such, the sensor unit operation item may output different values in the screen interface according to the types of the connected portable terminal 100. The operator may check which sensor is installed in the portable terminal 100 and whether a sensor, which is necessary for the virtual mobile application program currently under development or test, is installed by checking the sensor unit operation item. Further, the screen interface including the sensor unit operation item may select at least one of the sensors of the portable terminal 100, and select the sensor data collection time of the additionally selected sensor for the development and the test.

In the state where the screen interface is outputted according to the activation of the virtual mobile simulator 267, the operator may call a virtual mobile application program to be operated. To this end, the upper terminal 200 may include a configuration of the upper terminal storage unit 250 that stores a virtual mobile application program. If the virtual mobile application program is called from the upper terminal storage unit 250, the program operation unit 269 activates the virtual mobile application program. At this time, the program operation unit receives data, which is necessary for operating the virtual mobile application program, from the virtual mobile simulator 267, and applies the received data to the program. For example, the program operation unit 269 may receive a command to write a message, a command to write a message when a message writing screen is outputted, and a command to modify or cancel the written message from the virtual mobile simulator 267, and apply the command to the virtual mobile application program.

In particular, the program operation unit 269 may receive sensor data, which is generated in the portable terminal 100 and is transmitted from the portable terminal 100, from the virtual mobile simulator 267, and control the operation of various virtual mobile operation programs corresponding to the sensor data. For example, the program operation unit 269 may apply sensor data according to the characteristic of the virtual mobile application program, and the virtual mobile application program may perform various operations, for example, an operation that is necessary for game operation, an operation that is necessary for screen switching, an operation which is necessary for searching for a file or editing a file, etc., according to the sensor data. The operator may check whether an expected operation is performed for the sensor data by checking the operation state of the virtual mobile application program according to the sensor data.

The sensor data reception unit 263 receives sensor data from the portable terminal 100. Such a sensor data reception unit 263 may perform a buffering operation for sensor data transmitted by the portable terminal, and may transmit the received sensor data to the virtual mobile simulator 267. Further, the sensor data reception unit 263 may transmit the received sensor data to the sensor data output and storage unit 265.

The sensor data output and storage unit 265 receives sensor data transmitted by the portable terminal 100 from the sensor data reception unit 263, and output the received sensor data to the upper terminal display unit 240, and may control to store the sensor data in the upper terminal storage unit 250. The operator of the upper terminal 200 may check currently which sensor data is being collected and outputted by checking the sensor data outputted by the sensor data output and storage unit 265. Further, the operator of the upper terminal 200 may control the operation of the virtual mobile application program using sensor data stored in the upper terminal storage unit even in the situation where there is no portable terminal To this end, the sensor data output and storage unit 265 may control to automatically generate information about the sensor types of the sensor data, sensor data collection time and sensor data collection date, etc, and store the data in the upper terminal storage unit 250 when storing sensor data.

If the upper terminal 200 is connected with the portable terminal 100, the terminal link unit 261 supports transmission and reception of signals that are necessary for linking with the virtual mobile simulator. Further, the terminal link unit 261 may receive a request signal transmitted from the virtual mobile simulator 267 to the portable terminal 100, and transmit the received signal to the portable terminal 100. Such a terminal link unit 261 may operate various programs which are necessary for linking with the portable terminal 100.

As described above, the upper terminal 200 may provide a virtual portable terminal 100 environment based on the virtual mobile simulator 267, and may develop and test a virtual mobile application program to be operated in the portable terminal 100 based on the environment. In particular, the upper terminal 200 supports the portable terminal 100 to check the types of installed sensors through the direct link with the portable terminal 100. Further, the upper terminal 200 may support the operator to select a sensor that is necessary for developing and testing a virtual mobile application program and to select at least one of the sensor data collection times, and may easily obtain or operate only necessary sensor data by transmitting selected information along with the request signal to the portable terminal 100. In case there is no separate selection on the sensor data collection time, the upper terminal 200 may include the collection time, which is set as a default value, and the real-time collection time in the request signal.

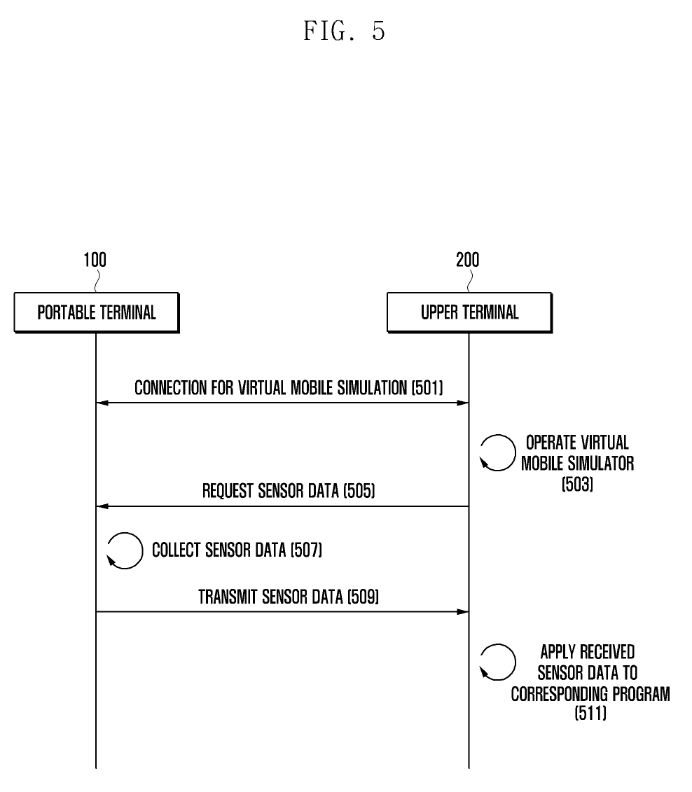

Each of the components of the system 10 for operating sensor data, and the roles and functions of each component according to exemplary embodiments of the present invention have been explained in the above. Hereinafter, an exemplary signal flow between system components for operating sensor data will be explained in more detail with reference to FIG. 5.

FIG. 5 is a flowchart illustrating a method of operating sensor data according to an exemplary embodiment of the present invention.

Referring to FIG. 5, if power is first supplied to a portable terminal 100, the controller may initialize each component of the portable terminal 100 using supplied power, and the upper terminal 200 may also complete the initialization process when power is supplied in a similar manner. Thereafter, the portable terminal 100 and the upper terminal 200 may perform a connection for the virtual mobile simulation in step 501. In exemplary implementations, the operator of the upper terminal 200 may control to connect the portable terminal 100 with the upper terminal 200 using a cable, or form a wireless communication channel using a near field communication module.

When the connection between the upper terminal 200 and the portable terminal 100 is completed, the upper terminal 200 may operate a virtual mobile simulator 267 according to the controller of the operator in step 503. The upper terminal 200 and the portable terminal 100 may transmit and receive an initialization signal which is necessary for operation of the virtual mobile simulation according to the operator's control or automatically. In an exemplary implementation, step 503 may be performed in the upper terminal 200 before step 501. That is, in the state where the virtual mobile simulator 267 is activated in the upper terminal 200, the connection between the portable terminal 100 and the upper terminal for the virtual mobile simulation may be performed.

The upper terminal 200 may transmit a sensor data collection request signal to the portable terminal according to the operator's request in step 505. At this time, the request signal transmitted to the portable terminal 100 by the upper terminal 200 may include information of sensor types and information about the sensor data collection time of the sensor, etc. To this end, the upper terminal 200 may output a screen interface, which includes an item that may select the sensor types of the portable terminal and an item that may select sensor data collection time, in the upper terminal display unit 240.

The portable terminal 100, which received the request signal from the upper terminal 200, may collect sensor data according to the received request signal in step 507. To this end, the portable terminal 100 may check the sensor types and the sensor data collection time by checking the request signal. Further, the portable terminal 100 may control to activate the sensor, and may collect sensor data from the sensor according to the collection time. If the sensor data is collected, the portable terminal 100 may transmit the collected data to the upper terminal 200 in step 509.

The upper terminal 200 may control to apply the received sensor data to the program in step 511. That is, the upper terminal 200 may support the operator to determine which operation is performed by applying the sensor data received in the virtual mobile application program operated in the virtual mobile simulator 267. Here, the virtual mobile application program includes routines which were designed for certain operations to be performed for the received sensor data, and may perform certain operations according to the received sensor data accordingly.

Further, the portable terminal 100 may automatically transmit the information of the types of the installed sensors to the upper terminal 200, or transmit the information of the sensor types to the upper terminal 200 according to the request of the upper terminal 200 in step 501. The upper terminal 200 may output the information of types of the received sensors in the screen interface in step 503.

As explained above, the method of operating sensor data of the exemplary embodiment of the present invention may provide substantially the same environment as the environment where a virtual mobile application program is operated in the portable terminal by collecting sensor data of at least one sensor installed in the portable terminal in the upper terminal that designs the virtual mobile application program applied to the portable terminal, and operating and testing the virtual mobile application program based on the collected sensor data. As such, the method of operating sensor data of the exemplary embodiment of the present invention may reduce the development time of a virtual mobile application program, and may support to develop and test the virtual mobile application program designed based on more accurate data.

The above-described portable terminal 100 may further include components that are not mentioned above, such as a near field communication module for a near field communication, a camera module for taking a still image/moving picture, an interface for data transmission and reception by a wired communication method or a wireless communication method of the portable terminal 100, an Internet communication module that performs Internet function by communicating with the Internet network, and a digital broadcast module that receives and replays a digital broadcast, etc. Such components may be modified according to the convergence trend of digital devices, and thus all such components cannot be listed here, but it is possible to include the above mentioned components and the components of the same level of that of such components in the device. Further, the portable terminal 100 of the exemplary embodiment of the present invention may exclude certain components form the above described configuration, or some components may be substituted by other components, which may be easily understood by those skilled in the art.

Further, the portable terminal 100 according to an exemplary embodiment of the present invention is an apparatus that includes various sensors, and may include all mobile communication terminals operated according to communication protocols corresponding to various communication systems, and all information communication devices and multimedia devices such as a portable multimedia player (PMP), a digital broadcasting player, a personal digital assistant (PDA), a music player (e.g., an MP3 player), a portable game terminal, a smart phone, a notebook computer, and a handheld PC, etc.

Certain aspects of the present invention can also be embodied as computer readable code on a computer readable recording medium. A computer readable recording medium is any data storage device that can store data which can be thereafter read by a computer system. Examples of the computer readable recording medium include Read-Only Memory (ROM), Random-Access Memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

At this point it should be noted that the exemplary embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the exemplary embodiments of the present invention as described above. Alternatively, one or more processors operating in accordance with stored instructions may implement the functions associated with the exemplary embodiments of the present invention as described above. If such is the case, it is within the scope of the present disclosure that such instructions may be stored on one or more processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A system for operating sensor data, the system comprising:
a portable terminal comprising at least one sensor, for activating a sensor from the at least one sensor according to a request signal transmitted from an upper terminal, for collecting sensor data of the sensor, and for transmitting the collected data to the upper terminal,
wherein the upper terminal controls to transmit a request signal that requests sensor data collection to the portable terminal, and apply the received sensor data to a virtual mobile application program to be installed in the portable terminal.

2. The system of claim 1, wherein the portable terminal further comprises:
a connection interface for connection with the upper terminal;
a sensor unit that comprises the at least one sensor; and
a controller for activating a corresponding sensor according to a corresponding request signal when a request signal is received from the upper terminal, for collecting sensor data, and for transmitting the collected sensor data to the upper terminal.

3. The system of claim 2, wherein the connection interface includes at least one of a wired connection interface and a wireless communication module.

4. The system of claim 2, wherein the controller checks sensor data collection time information included in the request signal, and collects sensor data according to the sensor data collection time information.

5. The system of claim 1, wherein the upper terminal comprises an upper terminal controller that controls collection and operation of the sensor data, and the upper terminal controller comprises:
a virtual mobile simulator for supporting operation of the virtual mobile application program;
a sensor data reception unit for receiving sensor data from the portable terminal, and for transmitting the received sensor data to the virtual mobile simulator; and
a program operation unit for applying sensor data transmitted by the virtual mobile simulator to the virtual mobile application program.

6. The system of claim 5, further comprising at least one of:
an upper terminal display unit for outputting the received sensor data; and
an upper terminal storage unit for storing the received sensor data.

7. The system of claim 5, wherein the virtual mobile simulator outputs a screen interface including an item that may select sensor types of the portable terminal, and an item that selects sensor data collection time.

8. The system of claim 7, wherein the portable terminal transmits to the upper terminal sensor type information including types of sensors installed in the portable terminal when connected with the upper terminal.

9. The system of claim 8, wherein the virtual mobile simulator outputs an item that selects at least one of the sensors included in the sensor type information in the display interface.

10. A method for operating sensor data, the method comprising:
connecting a portable terminal comprising at least one sensor with an upper terminal;
transmitting to the portable terminal a request signal that requests collection of sensor data of a sensor from the at least one sensor by the upper terminal;
activating the sensor and collecting sensor data of the activated sensor by the portable terminal;
transmitting the collected sensor data to the upper terminal; and
applying the received sensor data to a virtual mobile application program to be installed in the portable terminal by the upper terminal.

11. The method of claim 10, further comprising: activating a virtual mobile simulator that generates various input signals for developing or testing the virtual mobile application program in the upper terminal before or after the connection process.

12. The method of claim 10, wherein the connection process comprises at least one of:
connecting the portable terminal with the upper terminal using a wired connection; and
making a near field communication connection between the portable terminal and the upper terminal.

13. The method of claim 10, further comprising:
providing information of types of installed sensors to the upper terminal by the portable terminal before transmitting the request signal; and
outputting a screen interface comprising an item that selects at least one of the sensors by the upper terminal.

14. The method of claim 13, further comprising:
generating a request signal before transmitting the request signal,
wherein the generating of the request signal comprises:
selecting the at least one of the sensors of the portable terminal in the upper terminal; and
generating a request signal for the selected the at least one of the sensors.

15. The method of claim 14, wherein the generating of the request signal further comprises selecting sensor data collection time of the selected sensor.

16. The method of claim 15, wherein the collecting of the sensor data comprises collecting sensor data of the at least one of the sensors, according to the sensor data collection time by the portable terminal when the portable terminal activates the sensor according to the request signal.

17. The method of claim 10, further comprising at least one of:
outputting received sensor data by the upper terminal; and
storing received sensor data by the upper terminal.

18. The method of claim 10, wherein the connecting of the portable terminal with the upper terminal includes at least one of:
connecting the upper terminal with the portable terminal using a wired connection; and
connecting the upper terminal with the portable terminal using a wireless communication module.
